(19) United States
(12) Patent Application Publication
(10) Pub. No.: US 2022/0087225 A1
(43) Pub. Date: Mar. 24, 2022

(54) PET TREAT DISPENSER AND CHEW TOY

(71) Applicant: Yeti Corporation, Everett, WA (US)

(72) Inventor: Prasoon P. Khanal, Bothell, WA (US)

(73) Assignee: Yeti Corporation, Everett, WA (US)

(21) Appl. No.: 17/477,910

(22) Filed: Sep. 17, 2021

Related U.S. Application Data
(60) Provisional application No. 63/080,111, filed on Sep. 18, 2020.

(51) Int. Cl. A01K 15/02; A01K 5/01

(52) U.S. Cl. CPC A01K 15/026; A01K 5/0114

(57) ABSTRACT

One or more examples include a pet chew toy having a treat inserted within a cavity of the chew toy body, where the treat has been expanded to fill up the cavity and may even expand outside of the cavity. In one example, the chew toy is a dog chew toy and the expanded treat is microwaved hard cheese. The dog chew toy having an expanded treat positioned therein operates as a fun treat dispenser for the dog.

### CROSS-REFERENCE TO RELATED APPLICATION

This application is a non-provisional of U.S. Patent Application Ser. No. 63/080,111, filed Sep. 18, 2020, which is incorporated herein by reference.

### BACKGROUND

Pets love to play with chew toys. One known dog chew toy has an opening that extends longitudinally through the chew toy that is able to hold peanut butter. These type of chew toys provide for a longer duration of entertainment while providing a treat to the pet. It becomes more interesting for a dog to determine how to get at the peanut butter contained in the opening, and also provide a longer lasting treat than simply giving the dog a treat such as a milk bone treat.

For these and other reasons, a need exists for the present invention.

### SUMMARY

One or more examples include a pet chew toy having a treat inserted within a cavity of the chew toy, where the treat has been expanded to fill up the cavity and may even expand outside of the cavity. In one example, the chew toy is a dog chew toy.

In one example operation, a treat is inserted inside the cavity of the chew toy. The chew toy is then microwaved. This process allows the treat to expand and fill the cavity of the chew toy. A dog then gets to play with and attempt to access the treat that is now firmly encased inside the cavity of the chew toy.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIGS. 1-12 illustrate one or more examples of a chew toy having a treat and method of preparing the chew toy having a treat.

FIG. 1 illustrates one example of a chew toy.

FIG. 2 illustrates one example of a side view of the chew toy of FIG. 1.

FIGS. 3-5 illustrate one example of a treat body.

FIG. 5A is a partial view illustrating one example of an expanded treat position in a cavity of a chew toy.

FIG. 6 is a block diagram illustrating one example of a method of preparing a chew toy.

FIGS. 7-10 illustrate one example of a method of preparing a chew toy.

FIG. 11 illustrates one example of nuggets suitable of use in a chew toy.

FIG. 12 is a block diagram illustrating one example of making one or more nuggets suitable for use with a chew toy.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

One or more examples include a pet chew toy having a treat inserted within a cavity of the chew toy, where the treat has been expanded to fill up the cavity and may even expand outside of the cavity. This allows the pet chew toy to operate as a treat dispenser for a pet. In one example, the chew toy is a dog chew toy.

In one example operation, a treat is inserted inside the cavity of the toy. The toy is then microwaved. This process allows the treat to expand and fill the cavity of the toy. A dog then gets to play with and attempt to access the treat that is now firmly encased inside the cavity of the toy.

The unique chew toy design and process allows for the treat to expand and fill within the cavity of the toy, making it challenging and fun for a pet to get to the treat.

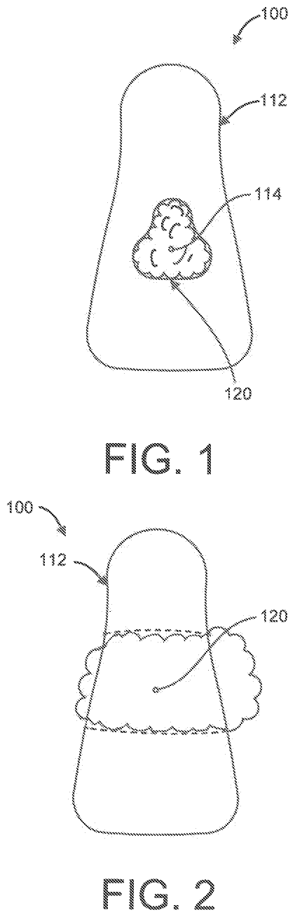

FIGS. 1 and 2 illustrate one example of a chew toy treat. FIG. 1 illustrates one example of a chew toy, illustrated at 100. FIG. 2 illustrates one example of a side view of the chew toy 100 of FIG. 1. The chew toy 100 includes an expanded treat located within a cavity of the chew toy, allowing the chew toy to operate as a treat dispenser for a pet.

In one example, the chew toy 100 includes a toy body 112 configured to hold an expanded treat 114. The toy body 112 is made of a pet safe material. In one example, the toy body includes a cavity 120 that holds the expanded treat 114. The expanded treat 114 substantially fills the cavity 120. In one example, the expanded treat 114 is expanded outside of the cavity 120.

In one example, the expanded treat 114 is made of an expanded hard cheese. In one aspect, the expanded cheese is a microwaved hard cheese. In one example, the expanded treat is a puffed cheese. In one example, the hard cheese is yak cheese (i.e., cheese made from yak milk).

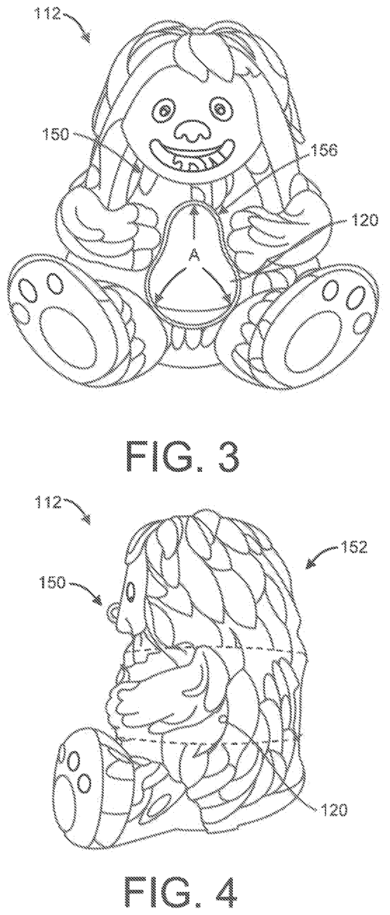

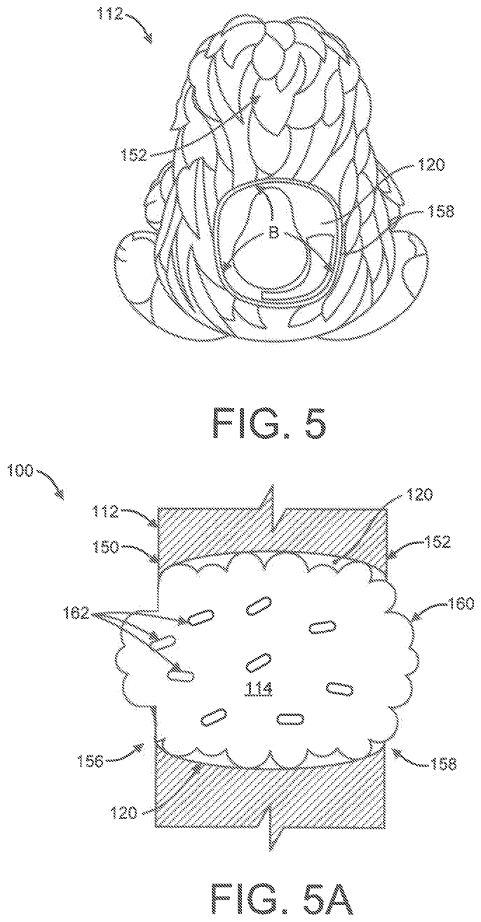

FIGS. 3-5 illustrate one example of toy body 112. FIG. 3 is one example of a front view of toy body 112. FIG. 4 is one example of a side view of toy body 112. FIG. 5 is one example of a rear view of toy body 112.

Referring to FIGS. 3-5, toy body 112 may take on many different shapes and sizes suitable for use as a chew toy. The toy body 112 may have a fun, ornamental design. The toy body can be made to take on most any color or form, such as a geometric form or shape of a character or object. The chew toy body illustrated is in the shape of a yeti.

The toy body 112 is made of a pet safe material. In one example, the toy body is made of a microwavable safe material. In one aspect, the toy body is made of a generally soft, molded material such as a soft plastic. In other aspects, the toy body is made of a generally hard material. In one example, the toy body is molded to a desired shape as one unit, and there is no need to screw, assemble or join parts. In other examples, the toy body can be made of multiple pieces.

The toy body 112 includes cavity 120 that allows for placement of a piece of treat within the cavity 120. In one example, toy body 112 includes a first side 150 and a second side 152. The first side 150 includes a first side opening 156 into cavity 120. The second side 152 includes a second side opening 158 into cavity 120. The first side opening 156 and the second side opening 158 can be smaller in size than the shape or diameter of the cavity 120 within the toy body 112.

In one example, first side opening 156 is smaller than second side opening 158. First side opening 156 has a cross-sectional area A that is smaller than the second side opening 156 cross-sectional area B. Further, first side opening 156 has a cross-sectional area A that is smaller than a maximum cross-sectional area of the cavity 120. In another example, the first side opening 156 is the same size or about the same size as the second side opening 158.

In operation, a treat is placed in the cavity 120. The treat is expanded while positioned in the cavity 120. Typically, the expanded treat will substantially fill the cavity 120. The first side opening 156 has a cross-sectional area A that is smaller than a maximum cross-sectional area of the cavity 120 or the cross-sectional area B of the second side opening 158. The smaller first side opening 156 aids in retaining the expanded treat within the cavity 120. The expanded treat may also extend outside of the cavity.

FIG. 5A is a partial view that illustrates one example of an expanded treat 114 positioned within toy body 112. For example, the hard cheese when microwaved takes on different material properties such as a puffed cheese. Microwaving hard cheese causes it to puff up to become a larger and crunchier treat. The treat puffs up and fills the cavity 120 and may even expand through the opening outside of the cavity 120. Once microwaved, the puffed up cheese is lodged inside the cavity making it fun (and more work) to be accessed by a pet. In one or more examples, the expanded treat may be a puffed cheese or a microwaved cheese that is made of yak cheese, cow cheese, or other type of cheese.

In other examples, the chew toy treat may be flavor coated or flavored in another manner, as indicated at 160. Additionally, the cheese may have other flavored edibles 162 added to the cheese. Such edibles may include bacon bits, dried chicken chunks, etc. The edibles 162 are maintained within the expanded cheese in the toy body 112 until accessed or eaten by a pet.

A detailed description of one hard cheese suitable for use with chew toy 112 is described in detail later in this application.

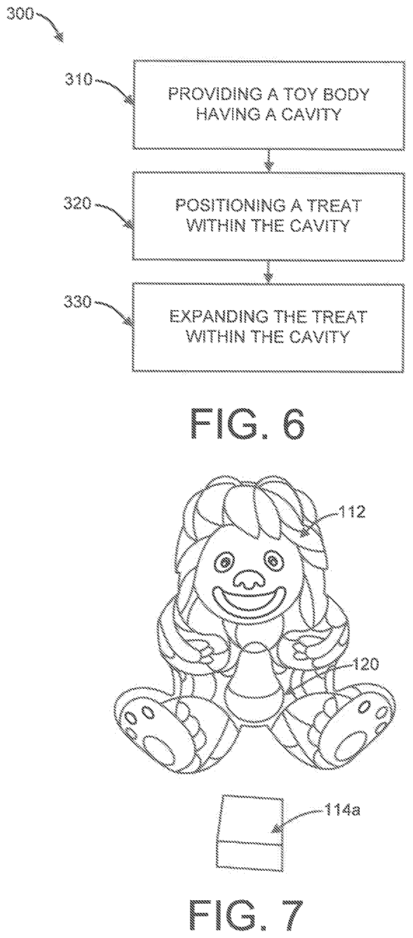

FIG. 6 is a block diagram illustrating one example of making a chew toy generally at 300. At 310, a toy body having a cavity is provided. At 320, a treat is positioned within the toy body. At 330, the treat is expanded within the cavity.

FIGS. 7-10 illustrate one example of a method of making a chew toy. In FIG. 7, toy body 112 is illustrated. In this example, the toy body 112 is molded in the form of a yeti, and includes cavity 120. Treat 114a is set in front of the toy body 112. In this example, the treat 114a is a piece of hard cheese or a hard cheese nugget. In one example, the hard cheese is yak cheese made from yak milk.

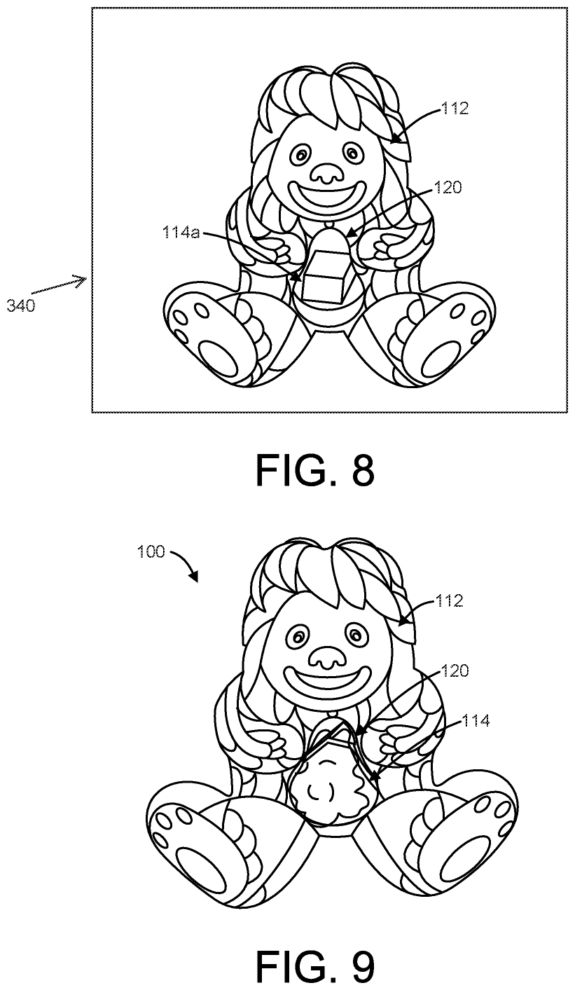

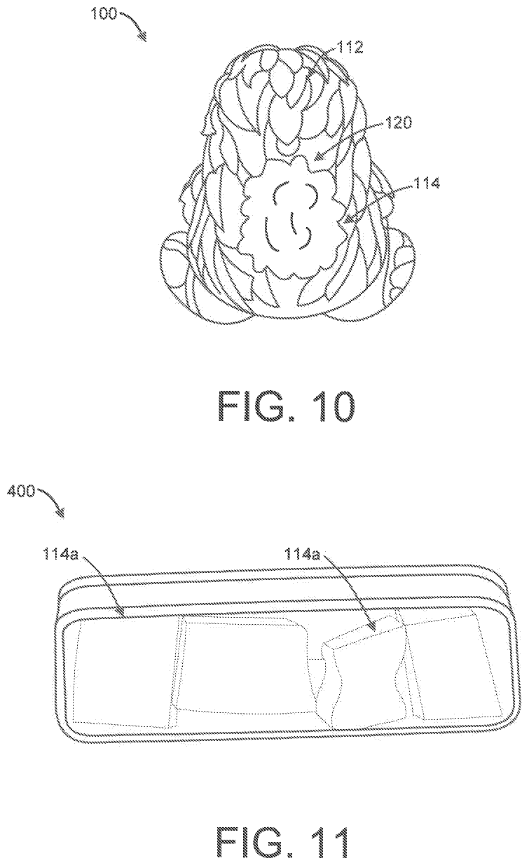

FIG. 8 illustrates positioning a treat 114a within the toy body 112. The treat 114a is positioned within cavity 120 of the toy body 112. The treat 114a is expanded while positioned within the cavity 120 of the toy body 112. In one example, the toy body 112 with the treat 114a positioned within the toy body 112 is microwaved, as illustrated by microwave 340. The treat is microwaved until it expands to fill the cavity 120, and may expand to extend beyond the cavity 120. FIG. 9 illustrates one example of a front view of the chew toy 100 with now expanded treat 114 positioned in the cavity 120. FIG. 10 illustrates one example of a rear view of the chew toy 100 with expanded treat 114 positioned within cavity 120, and also extending beyond cavity 120.

When microwaved, the expanded treat of hard cheese takes on new properties. The expanded treat is now in the form of expanded hard cheese or puffed cheese. As such the expanded treat fills the cavity and forms the chew toy 100. Once microwaved, the chew toy 100 is allowed to cool and then can be given to a pet such as a dog to be enjoyed as a treat. Dogs enjoy the taste of the expanded treat located within the chew toy, and attempt to scrape off and get to the entire treat over time. Since the bulk of the expanded treat is firmly encased inside the chew toy, it takes some time for the dog to be able to completely consume the treat.

In one example, a treat made of a hard cheese nugget is positioned within a toy body cavity. The hard cheese nugget is made from yak milk. The toy body is made of a solid flexible polymeric material. The toy body with the hard cheese nugget positioned therein is then microwaved. In one example, they are microwaved for about 60 seconds. The expanded treat (expanded hard cheese or puffed cheese) fills the cavity. The chew toy is allowed to cool off, and then can be given to a pet or dog to enjoy.

FIG. 11 illustrates one example of a package of treats 114a prior to expanding. The treats 114a are in the form of hard cheese nuggets. In one example, the hard cheese nuggets are made from yak milk. As illustrated, the treats 114a can vary in shape and size as long as they are positionable within the cavity of the toy body.

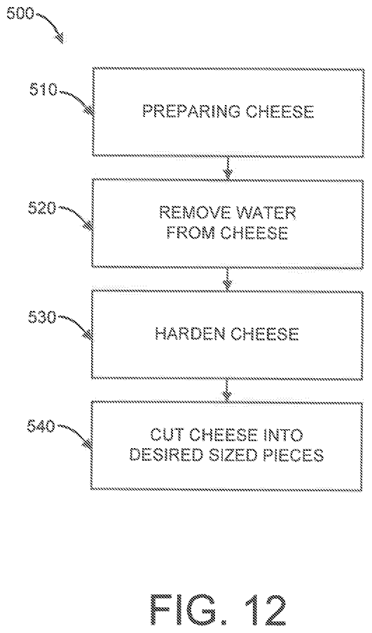

FIG. 12 illustrates one method of making a treat suitable for use in a chew toy detailed herein, shown generally at 500. At 510, the cheese is prepared. At 520, water is removed from the cheese. At 530, the cheese is hardened. At 540, the hardened cheese is cut into the desired size pieces for use in a chew toy.

In one example, milk is pasteurized, and then separated (curdled) by adding lime juice. The solid portion is separated from the liquid (whey) and placed in a burlap sack. The sacks are pressed to remove as much water as possible from the cheese.

Once the cheese sets, the set cheese is cut into log pieces. The pieces are air dried for 4-6 weeks over a small fire. The mild heat and smoke allow the cheese to dry and harden. Once hardened, the cheese log pieces can be cut into desired piece sizes for the chew toy treat or treat nuggets.

In one example, a lab analysis of the hardened cheese nugget treats results in a nugget treat having properties of 12% moisture, 70% protein, 4-5% fat and 0.5% crude fiber.

Actual shape, size, and color of the actual chew toy can vary. Although the chew toy body can take on various designs, it includes a cavity having a microwaveable treat inside that expands within the cavity. The chew toy can be a dog chew toy or other type of pet chew toy.

It is noted that a treat is illustrated in the figures by element number 114a. An expanded treat is represented by element number 114. A different reference number is used since an expanded treat has different material properties than a treat. For example, a treat 114a may be in the form of a nugget of hard cheese. An expanded treat can be in the form of puffed cheese which comes as a result of microwaving the hard cheese nugget. The expanded treat has different properties than the treat, and as such, expands within a chew toy cavity to substantially take up the space within the cavity. This results in the pet having to work harder to access the expanded treat within the chew toy.

It is to be understood that the features of the various exemplary embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1-20. (canceled)

21. A chew toy comprising:
a toy body having a cavity; and
an expanded treat positioned within the cavity that substantially fills the cavity, securing the expanded treat within the cavity.

22. The chew toy of claim 21, where the expanded treat is a hard cheese.

23. The chew toy of claim 22, where the expanded treat is a microwaved hard cheese.

24. The chew toy of claim 22, where the hard cheese is yak cheese.

25. The chew toy of claim 21, where the expanded treat is expanded outside of the cavity.

26. The chew toy of claim 21, where the expanded treat is expanded yak cheese.

27. The chew toy of claim 21, comprising:
where the toy body includes a first side having a first opening into the cavity and a second side having a second opening into the cavity.

28. The chew toy of claim 27, where the second opening is larger than the first opening.

29. The chew toy of claim 27, where the first opening has a first opening cross-sectional area, and where the cavity has a cavity cross-sectional area that is larger than the first opening cross-sectional area.

30. The chew toy of claim 27, where the chew toy has a generally longitudinally extending toy body, and where the cavity extends between the first opening and the second opening in a direction substantially orthogonal to the generally longitudinally extending toy body.

31. A method of making a chew toy comprising:
providing a toy body having a cavity;
positioning a treat within the cavity; and
expanding the treat to substantially fill the cavity.

32. The method of claim 31, comprising:
defining the treat to be made of a hard cheese.

33. The method of claim 32, comprising:
where the hard cheese is yak cheese.

34. The method of claim 31, comprising:
where expanding the treat to substantially fill the cavity comprises microwaving the toy body having the treat positioned within the cavity.

35. The method of claim 34, comprising microwaving the toy body until the treat expands beyond the cavity.

36. The method of claim 31, comprising:
defining the treat to be a hard cheese made from yak milk; and
where expanding the treat includes microwaving the toy body and hard cheese located within the chew toy body until it substantially fills the cavity.

37. A method of making a chew toy comprising:
providing an ornamental shaped toy body having a cavity disposed therein;
positioning an expandable cheese nugget within the cavity to form a treat assembly; and
microwaving the treat assembly to expand the cheese nugget to substantially fill the cavity.

38. The method of claim 37, comprising:
microwaving the cheese nugget until the cheese nugget expands beyond the cavity.

39. The method of claim 37, comprising:
making the cheese nugget from dried and hardened yak cheese.
